(19) United States
(12) Patent Application Publication
(10) Pub. No.: US 2003/0028628 A1
(43) Pub. Date: Feb. 6, 2003

(54) Method for storing, retrieving and managing configuration settings of computer systems

(75) Inventors: Jason Paul Irwin, Duluth, GA (US); Roger Terry Farmer, Duluth, GA (US)

Correspondence Address: Paul W. Martin, NCR Corporation, Law Department, 1700 S. Patterson Blvd., Dayton, OH, 45479-0001, US

(73) Assignee: NCR CORPORATION

(21) Appl. No.: 09/920,756

(22) Filed: Aug. 3, 2001

(51) Int. Cl. G06F 15/177; G06F 9/00; G06F 9/24

(52) U.S. Cl. 709/222; 713/1

(57) ABSTRACT

A method and apparatus for storing, retrieving, and managing registry settings for a computer system having handheld platform operating software is describe. A storage device and/or a network connection to another storage device or computer system are used to “mirror” the applicable parts of the registry to the storage device or network computer system in order that the computer system-specific configuration settings can be retrieved each time the computer system is booted.

### FIELD OF THE INVENTION

The present invention relates generally to configuring computer systems; and more particularly, to a method and apparatus for storing, retrieving, and managing configuration settings about computer systems. Still more particularly, the present invention relates to such a method and apparatus wherein the computer systems are running a handheld computer operating system; and still more particularly, to such a method and apparatus wherein the operating system is Windows CE.

### BACKGROUND ART

Embedded operating systems, for example the Windows CE operating system produced by the Microsoft Corporation, are designed for implementation and use in hand-held or palm-top computers and typically utilize persistent memory. Persistent memory, i.e., nonvolatile memory, is memory in which the memory contents are not lost when main or external power is removed and is normally implemented with special low-power random access memory (RAM) devices combined with batteries for maintaining the RAM contents for protracted time periods whether or not external power is available. Another example of persistent memory is a fixed disk or hard drive. Executable or application software and operating system software, once installed and configured on the hand-held platform are retained in either read only memory (ROM) or persistent memory and are not reinstalled or reconfigured after each powering off of the hand-held platform. In fact, such hand-held platforms or devices do not have a power off mode, instead the devices have a very-low power mode in which the device appears to be in a powered off state.

It is advantageous to be able to use a hand-held platform operating system and additional software on a computer system which is not a hand-held platform because the range of configurations available to retailers is broadened. A standard hardware platform or computer system, e.g., non hand-held platform computer system such as a typical Intel-based personal computer or workstation, or an existing terminal such as an NCR 7401 or 7454, is able to be used in configurations requiring only a hand-held platform, a stand-alone computer system, a networked workstation computer system, and a server computer system. Using a standard hardware platform for each of these configurations would reduce the overall cost of hardware and/or system purchases and increase the flexibility of hardware platform computer system configurations. Further, using standard hardware platforms increases the ability and ease of obtaining, maintaining, and storing replacement hardware components.

Across the range of hardware platform configurations, there is a corresponding range of installed operating software configurations. These operating software configurations include the operating system and application software and range from the hand-held platform, e.g., Windows CE, to the stand-alone computer system, e.g., Windows 98, to the networked workstation computer system, e.g., Windows NT workstation, and the server computer system, e.g., Windows NT server. Each operating software configuration has a corresponding cost associated with its installation and use on a hardware platform. It is advantageous to be able to install only the necessary operating software on the hardware platform corresponding to the intended use. For instance, hand-held platform configurations using Windows CE do not require Windows NT server software to function as an employment application kiosk. And conversely, a server computer system running inventory management database software on Windows NT server would not be executing on a hand-held platform. However, the ability to use a standard hardware platform across the range of configurations increases the possibility and amount of savings possible due to volume purchasing as well as increasing the flexibility and range of uses for a particular hardware platform.

Many hand-held platform operating software have no built-in method for maintaining configuration or registry settings, i.e., the hand-held platforms lack registry persistence. The term configuration settings and registry settings are used interchangeably to refer to computer system configuration settings including brightness, volume, energy saving, color depth, peripheral or object linking and embedding (OLE) point of sale (POS) (OPOS) device drivers, communication port, baud rate, and other settings. As a hand-held platform operating software is started or “booted up”, the operating software loads the configuration settings via a default registry object store. Typically, hand-held platforms are not powered off and do not necessitate reloading configuration information. However, if a computer system other than a hand-held platform is used to execute the hand-held platform operating software a need arises to store the configuration settings because these machines are either powered off or restarted or rebooted more frequently than the hand-held platform. Therefore, each time the computer system is booted or rebooted the configuration settings must be reset by a user. To users, this is frustrating, time consuming, and prone to mistakes in configuration settings being made by the user.

Further, because most computer systems need a specialized configuration, e.g., due to location and functionality, it is unacceptable to require configuration of the computer system every time it is booted up or restarted. Therefore, there is a need in the art to provide a method to store, retrieve, and manage configuration settings for computer systems having installed hand-held platform operating software.

Further, there is a need in the art to provide a redundant approach to storing, retrieving, and managing configuration settings in case of storage device or network connection failure.

### DISCLOSURE/SUMMARY OF THE INVENTION

It is therefore an object of the present invention to provide a method of storing, retrieving, and managing configuration settings for computer systems having hand-held platform operating software.

Another object of the present invention is to provide an approach to storing, retrieving, and managing configuration settings in case of storage device or network connection failure.

The above described objects are fulfilled by a method and apparatus for storing, retrieving, and managing configuration settings for a computer system having handheld platform operating software, e.g., a terminal. A storage device and/or a network connection to another storage device or computer system are used to “mirror” the applicable parts of the configuration setting storage or registry to the storage device or network computer system in order that the terminal-specific configuration settings can be retrieved each time the terminal is booted.

In one embodiment, a computer-implemented method of configuring a computer system executing a handheld platform operating software includes reading and storing generic configuration settings from a storage device to memory in the computer system. Operating software determines if computer system-specific configuration settings are stored on an attached storage device and if the configuration settings are stored on the storage device, the operating software copies the computer system-specific configuration settings to memory in the computer system. Additionally, the operating software determines if computer system-specific configuration settings are stored on a network and if the configuration settings are stored on the network, the operating software copies the computer system-specific configuration settings from the network to memory in the computer system. The operating software sets a boot status setting in memory of the computer system and causes the computer system to reboot, e.g., perform a warm restart.

An apparatus aspect of the present invention includes a processor for receiving and transmitting data and a memory coupled to the processor. The memory includes generic configuration settings and instructions which, when executed by the processor, cause the processor to load generic configuration settings. The instructions further cause the processor to load computer system-specific configuration settings and reboot the computer system.

In another embodiment of the present invention, a computer implemented method of storing configuration settings of a computer system executing a handheld platform operating software includes determining if a storage device is connected to the computer system. If the storage device is connected to the computer system, the operating software stores computer system-specific configuration settings to the storage device. The operating software determines if the computer system is connected to a network connection having a second computer system and if the network connection is connected to the computer system stores computer system-specific configuration settings to the second computer system using the network connection.

An apparatus aspect of the present invention includes a processor for receiving and transmitting data and a memory coupled to the processor. The memory includes computer system-specific configuration settings and instructions which, when executed by the processor, cause the processor to receive a specified event. The operating software determines if the computer system is connected to a storage device, and if the computer system is connected to a storage device, stores the computer system-specific configuration settings to the storage device. In a further embodiment, the apparatus include additional sequences of instructions which, when executed by the processor, cause the processor to determine if the computer system is connected to a network connection having a second computer system. If the computer system is connected to the network connection having a second computer system, the operating software stores the computer system-specific configuration settings to the second computer system.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a top level block diagram of a computer system usable with an embodiment of the present invention;

FIG. 2 is a top level functional diagram of the flow of control of retrieving and setting configuration settings in accordance with an embodiment of the present invention; and

FIG. 3 is a top level functional diagram of the flow of control of storing configuration settings in accordance with an embodiment of the present invention.

### BEST MODE FOR CARRYING OUT THE INVENTION

A method and apparatus for storing, retrieving, and managing configuration information for computer systems having hand-held platform operating software are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

### Top Level Description

Most configuration settings for a computer system or POS terminal are stored in the registry of the operating software. The present invention uses a storage device and/or a network connection to another storage device or computer system to “mirror” the applicable parts of the registry to the storage device or network computer system or storage device so the computer system-specific configuration settings can be retrieved each time the computer system is booted.

### Detailed Description

A detailed description of an embodiment of the present invention is now provided.

Hardware Overview

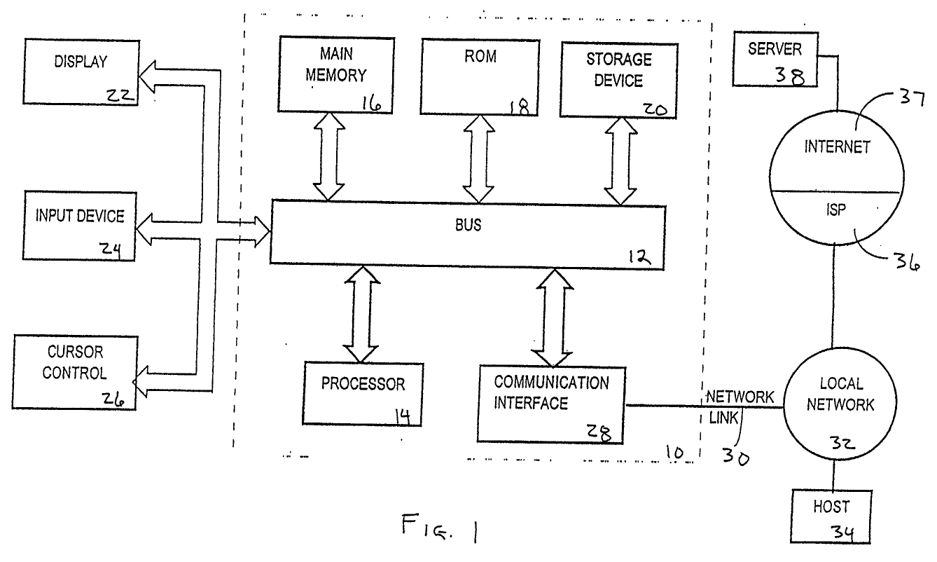

FIG. 1 is a block diagram illustrating an exemplary computer system 10 upon which an embodiment of the invention may be implemented. The present invention is usable with currently available terminals, personal computers, mini-mainframes and the like.

Computer system 10 includes a bus 12 or other communication mechanism for communicating information, and a processor 14 coupled with the bus 12 for processing information. Computer system 10 also includes a main memory 16, such as a random access memory (RAM) or other dynamic storage device, coupled to the bus 12 for storing instructions to be executed by processor 14. Main memory 16 also may be used for storing temporary variables or other intermediate information during execution of instructions executed by processor 14. Computer system 10 further includes a read only memory (ROM) 18 or other static storage device coupled to the bus 12 for storing static information and instructions for the processor 14. A storage device 20, such as a magnetic disk or optical disk, is provided and coupled to the bus 12 for information, configuration settings, and instructions.

Computer system 10 may be coupled via the bus 12 to a display 22, such as a cathode ray tube (CRT) or a flat panel display, for displaying information to users. An input device 24, including alphanumeric and function keys, is coupled to the bus 12 for communicating information and command selections to the processor 14. Another type of user input device is cursor control 26, such as a mouse, a trackball, or cursor direction keys for communicating direction information and command selections to processor 14 and for controlling cursor movement on the display 22. This input device typically has two degrees of freedom in two axes, a first axis (e.g., x) and a second axis (e.g., y) allowing the device to specify positions in a plane.

The invention is related to the use of computer system 10, such as the illustrated system of FIG. 1, to store, retrieve, and manage configuration settings. According to one embodiment of the invention, computer system-specific configuration settings are stored in storage device 20 or generic configuration settings are stored in ROM 18. Computer system-specific configuration settings may additionally be stored on host 34 or server 38 (both described in detail below) being accessible to computer system 10 via communication interface 28. When the flow of power to computer system 10 is stopped the contents of main memory 16 are lost. The reapplication of power to computer system 10 causes the processor 14 to reload the configuration settings from ROM 18 into main memory 16 and restart the hand-held platform operating software. Instructions and computer system-specific configuration settings may be read into main memory 16 from another computer-readable medium, such as storage device 20.

However, the computer-readable medium is not limited to devices such as storage device 20 or ROM 18. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 16 causes the processor 14 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 10 also includes a communication interface 28 coupled to the bus 12. Communication interface 28 provides two-way data communication as is known. For example, communication interface 28 may be an integrated services digital network (ISDN) card, a digital subscriber line (DSL) card, or a modem to provide a data communication connection to a corresponding type of telephone line. As another example, communication interface 28 may be a local area network (LAN) card to provide a data communication connection to a compatible LAN. Wireless links may also be implemented. In any such implementation, communication interface 28 sends and receives electrical, electromagnetic or optical signals which carry digital data streams representing various types of information. Of particular note, the communications through interface 28 permit transmission or receipt of information necessary to load the hand-held platform software and specify computer system unique parameters. For example, two or more computer systems 10 may be networked together in a conventional manner with each using the communication interface 28.

Network link 30 typically provides data communication through one or more networks to other data devices. For example, network link 30 may provide a connection through local network 32 to a host computer 34 or to data equipment operated by an Internet Service Provider (ISP) 36. ISP 36 in turn provides data communication services through the world wide packet data communication network now commonly referred to as the “Internet” 37. Local network 32 and Internet 37 both use electrical, electromagnetic or optical signals which carry digital data streams. The signals through the various networks and the signals on network link 30 and through communication interface 28, which carry the digital data to and from computer system 10, are exemplary forms of carrier waves transporting the information.

Computer system 10 can send messages and receive data, including program code, through the network(s) (Internet 37), network link 30 and communication interface 28. In the Internet example, a server 38 might transmit a requested code for an application program through Internet 37, ISP 36, local network 32 and communication interface 28.

The received code may be executed by processor 14 as it is received, and/or stored in storage device 20, or other non-volatile storage for later execution. In this manner, computer system 10 may obtain application code in the form of a carrier wave. Further, as described in detail below, specific information, i.e., computer system-specific, unique parameters, is obtained from another computer system, e.g., host 34 or server 38, via communication interface 28.

In contrast to computer system 10 described above, a hand-held platform may include fewer components than the computer system 10 of FIG. 1. Specifically, the display 22, input device 24, and the cursor control 26 are often integrated into a single unit, typically a touch sensitive display, and include writing recognition instructions in either main memory 16 or ROM 18 for receiving input and/or cursor control. Additionally, storage device 20 is not usually a part of the hand-held platform because main memory 16 is a type of persistent memory. Thus, software, configuration settings, and information are stored in main memory 16 instead of storage device 20. The hand-held platform includes main memory 16, i.e., persistent memory, ROM 18, bus 12, processor 14, and communication interface 28 as shown in conjunction with the computer system 10 of FIG. 1.

### Functional Overview

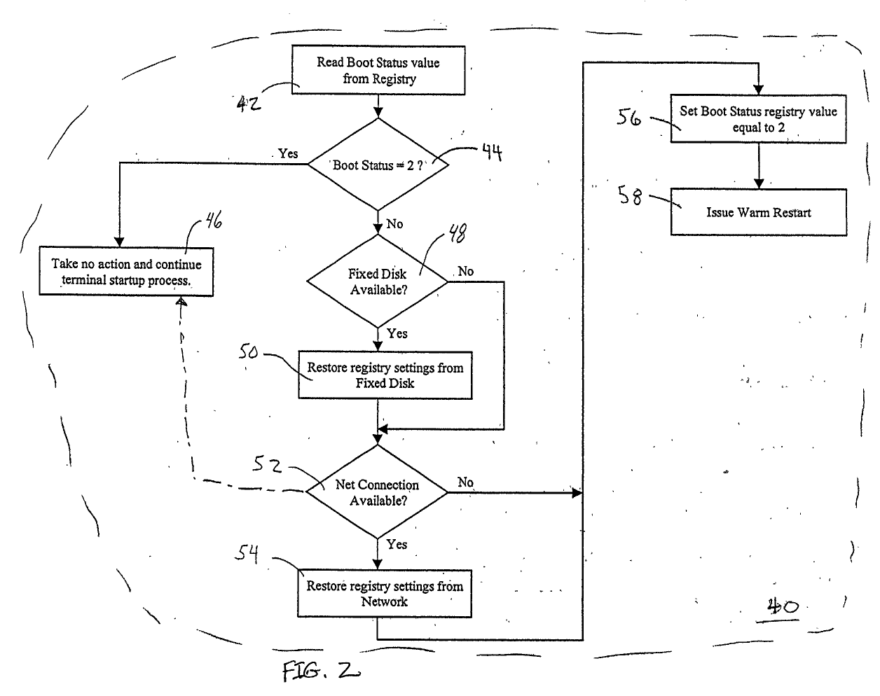

The present invention is now described with reference FIG. 2 and the flow of control of a portion of the operating software as referenced by numeral 40 (dashed lines). At step 42 during boot up or initialization of the computer system 10, the default registry containing generic, i.e., non-computer system-specific, configuration settings are loaded into volatile memory, e.g., main memory 16, from a storage location. As described above, the storage location may be a ROM 18, disk-on-chip, storage device 20, or a network server 38 or host 34. The operating software determines at step 44 whether this is the first time the computer system 10 has booted up, i.e., initial boot sequence and whether any computer system-specific configuration settings are available in memory 16. If this is not the initial boot sequence, the flow of control proceeds to step 46 and the computer system is booted normally using the registry settings stored in memory 16. No further steps of the flow are executed and the operating software prepares the computer system 10 for use by a user.

If this is the first time the computer system 10 has booted up, the flow of control proceeds to step 48. In further steps, the operating software then attempts to locate and retrieve computer system-specific configuration settings from other storage devices or computer systems, as described below.

In order to locate the configuration settings, the operating software determines if the computer system 10 includes an attached storage device 20 in step 48. If a storage device 20 is available, the operating software attempts to locate the registry settings stored on the storage device. If registry settings are located on the storage device 20, the flow of control proceeds to step 50 and the operating software copies the configuration settings from the storage device 20 to memory. After copying the configuration settings from the storage device 20, the flow of control proceeds to step 52. If either a storage device 20 or registry settings are not found in step 48, the flow of control proceeds to step 52.

During step 52, the operating software determines if a network connection, e.g., network link 30, is available to the computer system 10. If a network link 30 is available, the flow proceeds to step 54 where the operating software transmits a request to a server 38 to obtain any computer system-specific configuration settings to be copied or restored to the memory 16 of the computer system 10. The computer system 10 receives the computer system-specific configuration settings from the server 38 and stores the settings in main memory 16. The flow of control proceeds to step 56. Any configuration settings found on the server 38 override configuration settings found on the storage device 20. That is to say, if configuration settings are found at both the storage device 20 and the server 38, the server-provided configuration settings will be used instead of the storage device 20 configuration settings. If a network link 30 is unavailable, the flow continues to step 56.

After the operating software restores, i.e., locates and obtains, any computer system-specific configuration settings, a registry setting in main memory 16 is updated in step 56 to indicate that the next boot of the computer system 10 will not be the initial boot so the above process or steps need not be repeated. After the registry setting is updated, the flow of control proceeds to step 58 and the operating software executes a particular command causing the computer system 10 to perform a “warm restart”. A warm restart allows the computer system 10 operating software to reinitialize or “reboot” without reinitializing the configuration settings stored in the registry.

After the computer system 10 operating software boots a second time, i.e., the reboot completes, all computer system-specific configuration settings are available for any computer system-specific device drivers and/or application software necessary for the specific computer system 10 configuration. The computer system 10 is now configured and usable by a user.

In an alternate embodiment, if the operating software fails to detect a storage device 20 (step 48) and fails to detect a network link 30 (step 52), the operating software will not perform steps 56 and 58 and will instead continue the normal boot process (shown by a dash dot line) using the existing configuration settings and proceed to step 46.

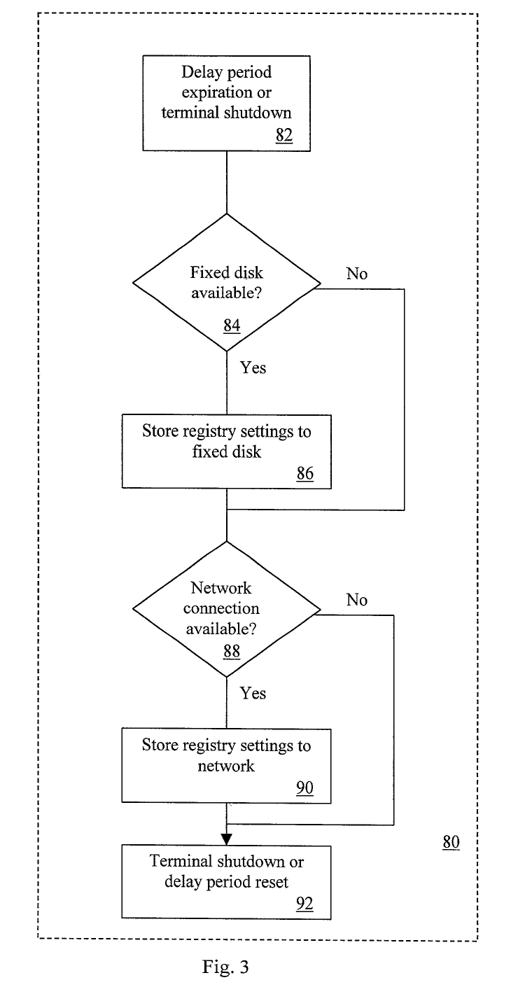

Additional functionality of an embodiment of the present invention is now described with reference to the flow of control of a portion of the operating software as referenced by numeral 80 (dashed lines) of FIG. 3. After the computer system 10 has been configured, either for a first time use by a user or for subsequent uses by the steps described in detail above, the computer system-specific configuration settings need to be stored for future use. The flow of control begins at step 82 upon expiration of a specific delay period or at computer system 10 shutdown time, the configuration settings are stored in accordance with the following steps. The specific delay period may be set by a user, e.g., every ten minutes, or may be a configuration setting obtained by the above steps.

In step 84, the operating software determines if a storage device 20 is present in the computer system 10. If a storage device 20 is present in the computer system 10, the operating software proceeds to step 86 and the computer system's entire registry or configuration settings are stored on storage device 20. After the registry settings are stored to the storage device 20 and in the case where a storage device 20 is not found in the computer system 10, the flow of control proceeds to step 88 and the operating software determines if a network link 30 is available to the computer system 10.

If a network link 30, is present, the computer system's entire registry settings are stored on a host 34 or server 38 (step 90) on the network when the delay period expires or the computer system 10 shuts down. After the registry settings are stored on the host 34 or server 38 on the network and in the case where a network link 30 is unavailable to the computer system 10, the flow of control proceeds to step 92 and the operating software continues to execute, i.e., either shutting down the computer system 10 or continuing execution and resetting the delay period.

An attempt is made to save the configuration settings to the storage device 20 before the network link 30 because determining whether or not a fixed disk exists is normally faster than determining whether or not a network link 30 or host 34 or server 38 exists. Typically, the storage device 20 has a larger bandwidth than the network link 30, as well.

In an alternate embodiment, only certain registry settings are stored on the expiration of a delay period or when the computer system 10 is shutting down. For example in one implementation, if the settings are being stored to a storage device 20, all the settings may be stored; however, if a bandwidth limited network link 30 is being used to store the settings, only certain registry settings may be stored.

In a further alternate embodiment, the specific registry settings to be stored using the network link 30 are specified in the registry settings. For example, the registry settings may indicate that only the contrast, brightness, and volume configuration settings are to be stored using the network link 30 in order to minimize the bandwidth required.

In a further embodiment, more than a single attempt may be made to determine if either or both of the storage device 20 or network link 30 are present. Additionally, if a network link 30 is not to be used with a computer system 10, then only a storage device 20 will be accessed by the operating software.

While there have been described and illustrated specific embodiments of the invention, it will be clear that variations in the details of the embodiments specifically illustrated and described may be made without departing from the true spirit and scope of the invention as defined in the appended claims.

Advantageously, through use of the present invention, a method of storing, retrieving, and managing configuration settings for a computer system is provided.

Further, a method of storing, retrieving, and managing configuration settings for a computer system is provided in the event of a storage device or network connection failure.

What is claimed is:

1. A computer implemented method of configuring a computer system executing a handheld platform operating software comprising the steps of:
reading generic configuration settings from a storage device;
storing generic configuration settings in a memory;
determining if first computer system-specific configuration settings are stored on a storage device;
if said first computer system-specific configuration settings are stored on said storage device, copying said first computer system-specific configuration settings to said memory;
determining if second computer system-specific configuration settings are stored on a network;
if said second computer system-specific configuration settings are stored on a network, copying said second computer system-specific configuration settings to said memory;
setting a boot status setting; and
rebooting said computer system.

2. The computer implemented method as claimed in claim 1, wherein the configuration settings include at least one of brightness, volume, energy saving, color depth, peripheral device, delay period, communication port, and baud rate settings.

3. The computer implemented method as claimed in claim 1, wherein the configuration settings identify configuration settings to be stored.

4. A computer implemented method of configuring a computer system executing a handheld platform operating software comprising the steps of:
reading generic configuration settings from a storage device;
storing generic configuration settings in a memory;
determining if first computer system-specific configuration settings are stored on a storage device;
if said first computer system-specific configuration settings are stored on said storage device, copying said first computer system-specific configuration settings to said memory;
setting a boot status setting; and
rebooting said computer system.

5. A computer implemented method of configuring a computer system executing a handheld platform operating software comprising the steps of:
reading generic configuration settings from a storage device;
storing generic configuration settings in a memory;
determining if second computer system-specific configuration settings are stored on a network;
if said second computer system-specific configuration settings are stored on a network, copying said second computer system-specific configuration settings to said memory;
setting a boot status setting; and
rebooting said computer system.

6. A computer implemented method of configuring a computer system comprising the steps of:
loading generic configuration settings;
loading computer system-specific configuration settings; and
rebooting the computer system.

7. The computer implemented method as claimed in claim 6 wherein the computer system-specific configuration settings are read from a storage device or a network.

8. The computer implemented method as claimed in claim 6 wherein computer system-specific configuration settings are read from a storage device and comprising the further step of:
loading computer system-specific configuration settings from a network.

9. The computer implemented method as claimed in claim 8 comprising the further step of:
using computer system-specific configuration settings from the network.

10. The computer implemented method as claimed in claim 6, wherein the configuration settings include at least one of brightness, volume, energy saving, color depth, peripheral device, delay period, communication port, and baud rate settings.

11. The computer implemented method as claimed in claim 6, wherein the configuration settings identify configuration settings to be stored.

12. A system for configuring a computer system comprising:
a processor for receiving and transmitting data; and
a memory coupled to the processor, said memory having stored therein sequences of instructions which, when executed by said processor, cause said processor to load generic configuration settings, load computer system-specific configuration settings, and reboot the computer system.

13. The system as claimed in claim 12 further comprising:
a storage device coupled to said processor, said storage device having stored therein computer system-specific configuration settings; and
wherein said memory further includes sequences of instructions which, when executed by said processor, cause said processor to read computer system-specific configuration settings from said storage device.

14. The system as claimed in claim 12 further comprising:
a communication interface coupled to said processor, said communication interface coupled to another computer system having stored therein computer system-specific configuration settings; and
wherein said memory further includes sequences of instructions which, when executed by said processor, cause said processor to read computer system-specific configuration settings from said computer system via said communication interface.

15. The computer implemented method as claimed in claim 12, wherein the configuration settings include at least one of brightness, volume, energy saving, color depth, peripheral device, delay period, communication port, and baud rate settings.

16. The computer implemented method as claimed in claim 12, wherein the configuration settings identify configuration settings to be stored.

17. A computer-implemented method of storing configuration settings of a computer system executing a handheld platform operating software comprising the steps of:
determining if a storage device is connected to the computer system;
if the storage device is connected to the computer system, storing computer system-specific configuration settings to the storage device;
determining if the computer system is connected to a network connection having a second computer system; and
if the network connection having a second computer system is connected to the computer system, storing computer system-specific configuration settings to the second computer system.

18. A computer implemented method of storing configuration settings of a computer system comprising the steps of:
receiving a specified event at the computer system;
determining if a storage device is connect to the computer system; and
if the storage device is connected to the computer system, storing computer system-specific configuration settings to the storage device.

19. The computer implemented method as claimed in claim 18 wherein the specified event includes at least one of expiration of a delay period and computer system shutdown.

20. A computer implemented method of storing configuration settings of a computer system comprising the steps of:
receiving a specified event at the computer system;
determining if the computer system is connected to a network connection having a second computer system; and
if the computer system is connected to the network connection having a second computer system, storing computer system-specific configuration settings to the second computer system.

21. The computer implemented method as claimed in claim 20 wherein the specified event includes at least one of expiration of a delay period and computer system shutdown.

22. A system for storing configuration settings of a computer system comprising:
a processor for receiving and transmitting data; and
a memory coupled to the processor, said memory having stored therein computer system-specific configuration settings and sequences of instructions which, when executed by said processor, cause said processor to receive a specified event, determine if the computer system is connected to a storage device, and if the computer system is connected to a storage device, store the computer system-specific configuration settings to the storage device.

23. The system as claimed in claim 22 wherein said memory further comprises sequences of instructions which, when executed by said processor, cause said processor to determine if the computer system is connected to a network connection having a second computer system and if the computer system is connected to the network connection having a second computer system, store the computer system-specific configuration settings to the second computer system.
